(19) United States
(12) Patent Application Publication
(10) Pub. No.: US 2013/0231978 A1
(43) Pub. Date: Sep. 5, 2013

(54) INTEGRATED CASE MANAGEMENT HISTORY AND ANALYTICS

(71) Applicants: Francisco P. Curbera, Hawthorne, NY (US); Yurdaer N. Doganata, Hawthorne, NY (US); Rania Y. Khalaf, Cambridge, MA (US); Geetika T. Lakshmanan, Cambridge, MA (US); Axel Martens, Hawthorne, NY (US); Kevin P. McAuliffe, Hawthorne, NY (US); Nirmal K. Mukhi, Hawthorne, NY (US); Aleksander A. Slominski, Hawthorne, NY (US)

(72) Inventors: Francisco P. Curbera, Hawthorne, NY (US); Yurdaer N. Doganata, Hawthorne, NY (US); Rania Y. Khalaf, Cambridge, MA (US); Geetika T. Lakshmanan, Cambridge, MA (US); Axel Martens, Hawthorne, NY (US); Kevin P. McAuliffe, Hawthorne, NY (US); Nirmal K. Mukhi, Hawthorne, NY (US); Aleksander A. Slominski, Hawthorne, NY (US)

(73) Assignee: INTERNATIONAL BUSINESS MACHINES CORPORATION, Armonk, NY (US)

(21) Appl. No.: 13/409,403

(22) Filed: Mar. 1, 2012

(51) Int. Cl. G06Q 10/06

(52) U.S. Cl. 705/7.36

(57) ABSTRACT

A method, system and computer program product for determining health of a case. The method includes the steps of: obtaining at least one correlated trace from (i) task descriptions or (ii) data related to the task descriptions or a process instance; calculating at least one current metric using (i) the task descriptions, (ii) the data, (iii) the correlated trace or (iv) a first model; calculating at least one prognostic metric using a second model; and creating at least one combination metric from the current metric and the prognostic metric; where at least one of the steps is carried out using a computer device.

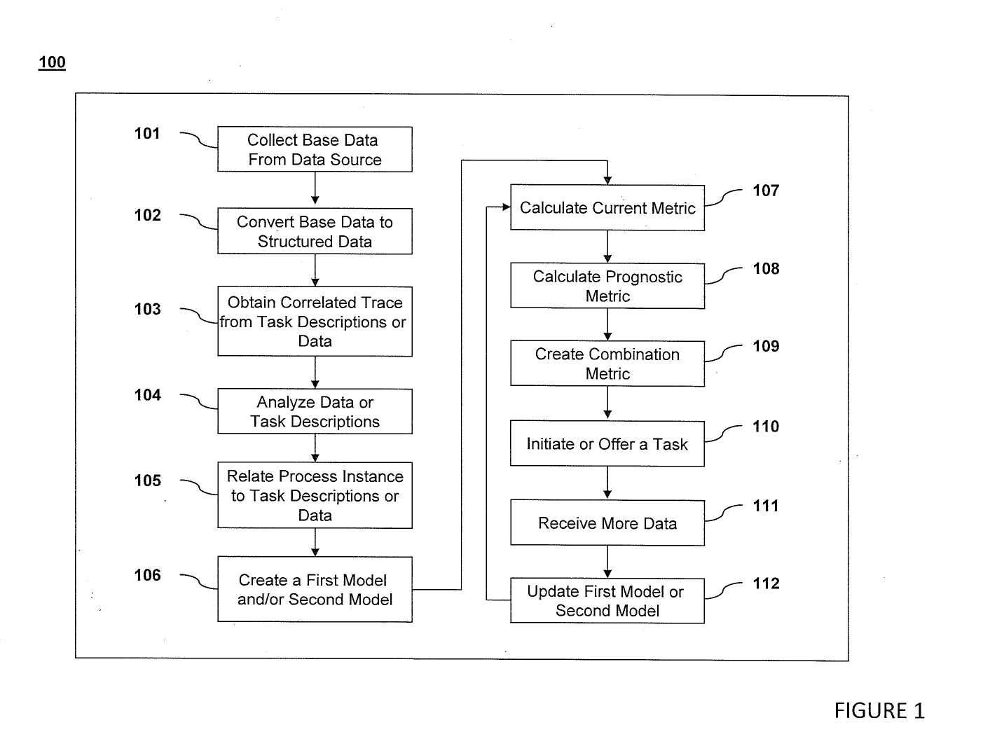

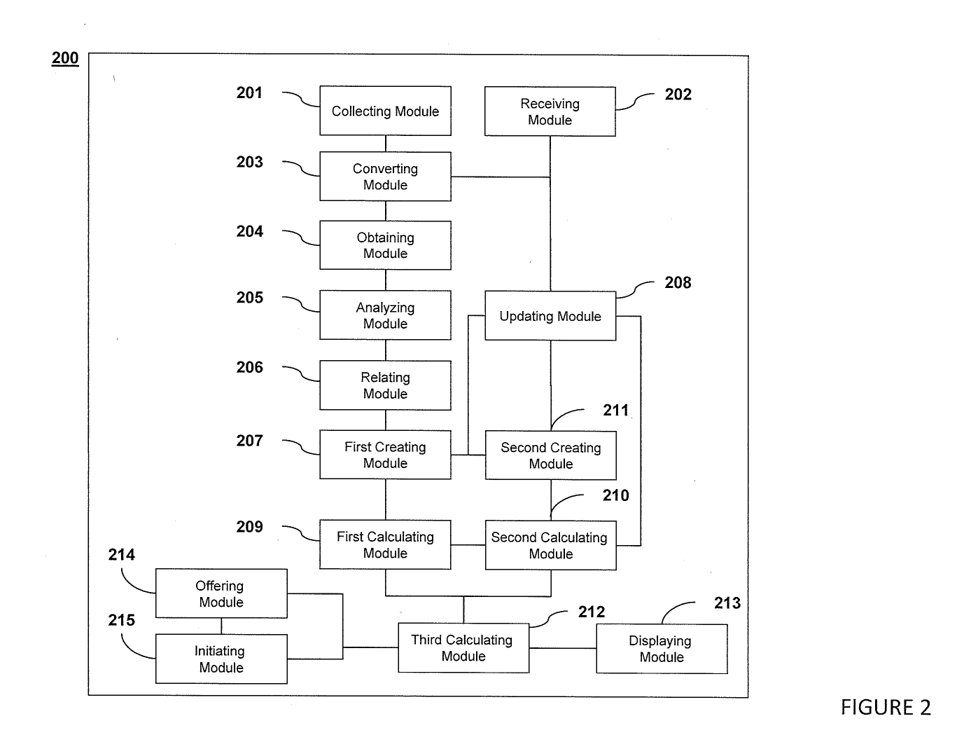

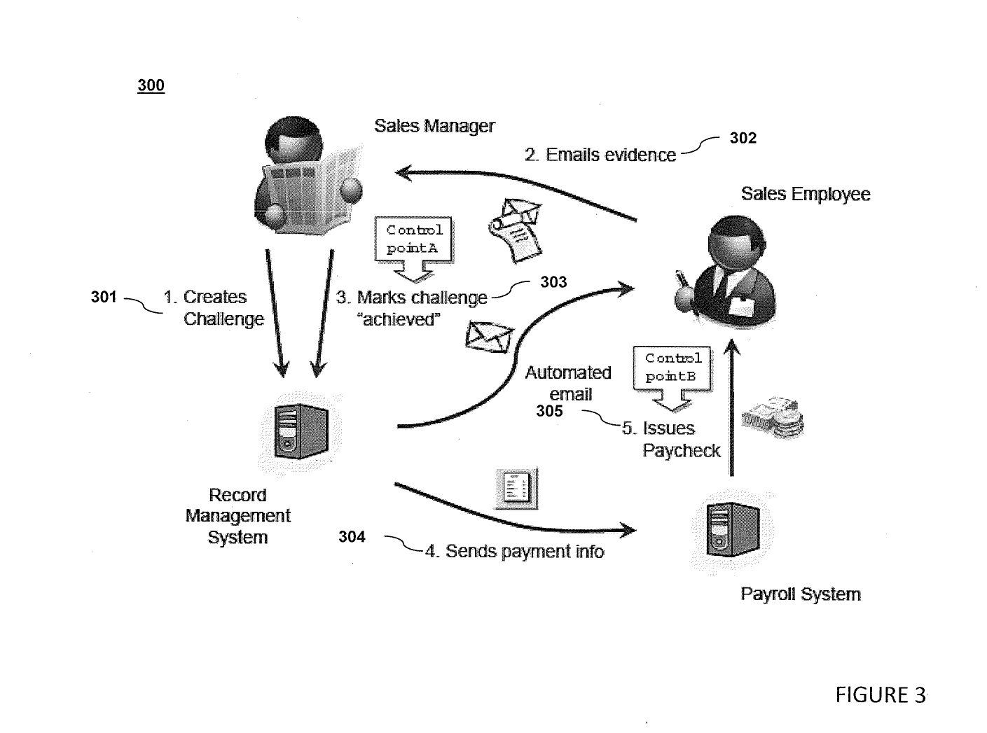

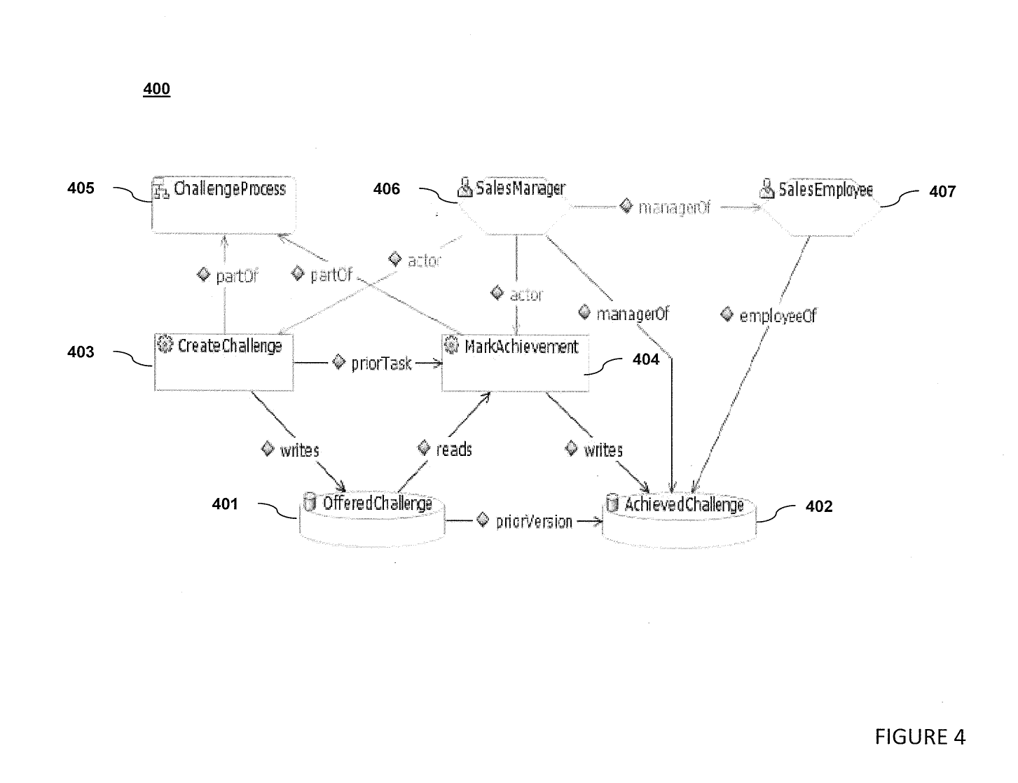

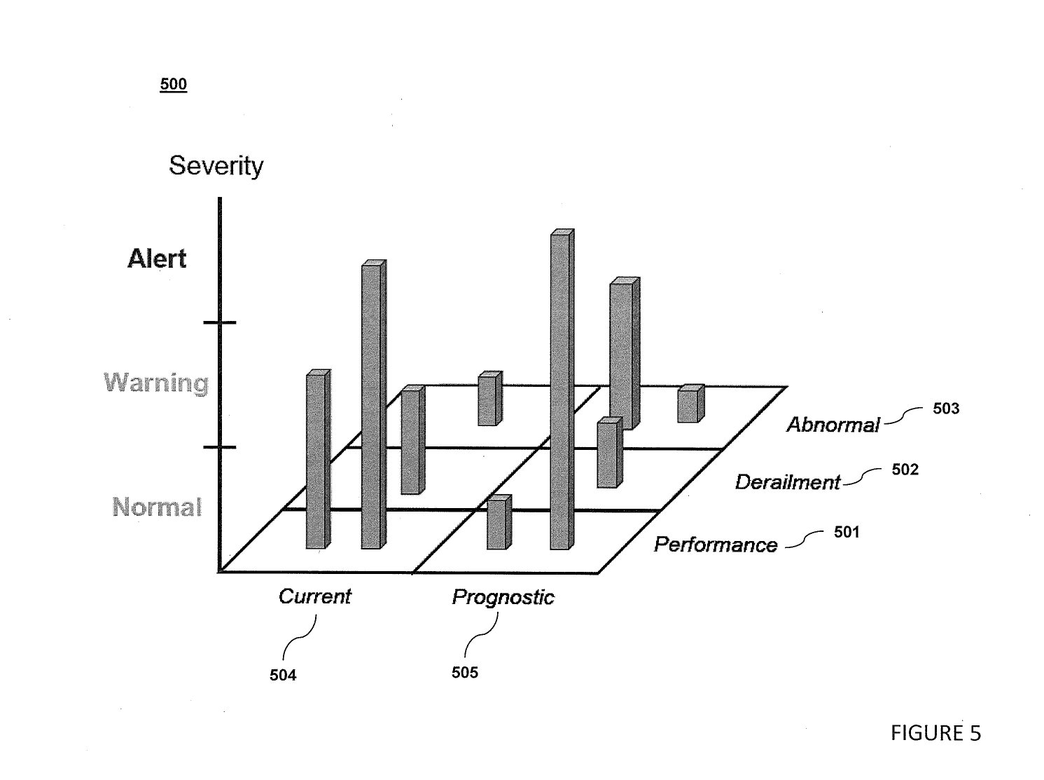

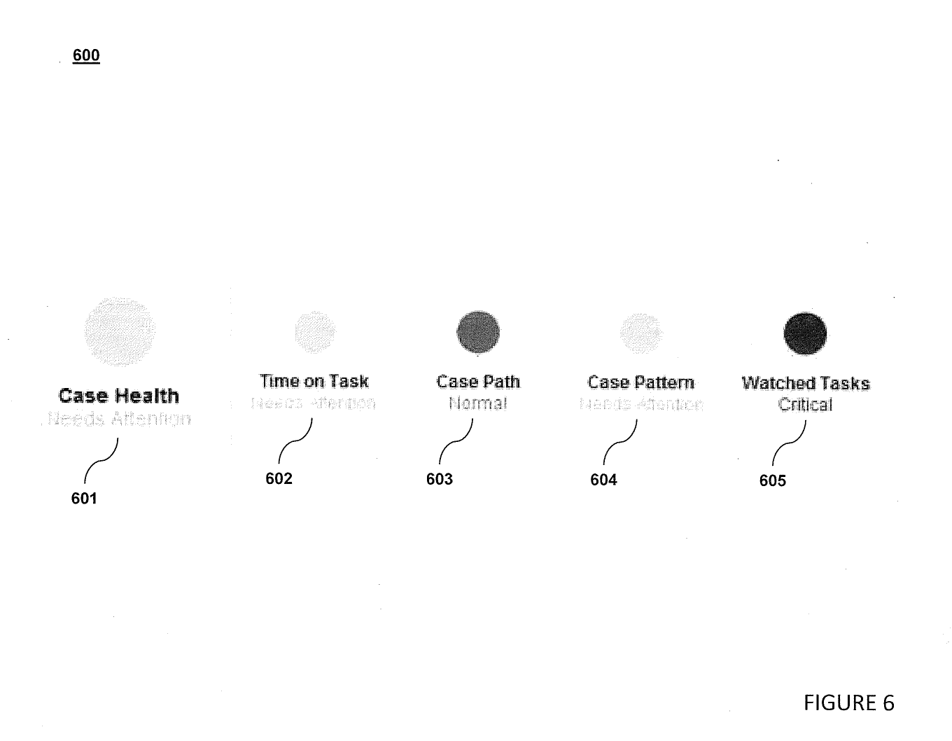

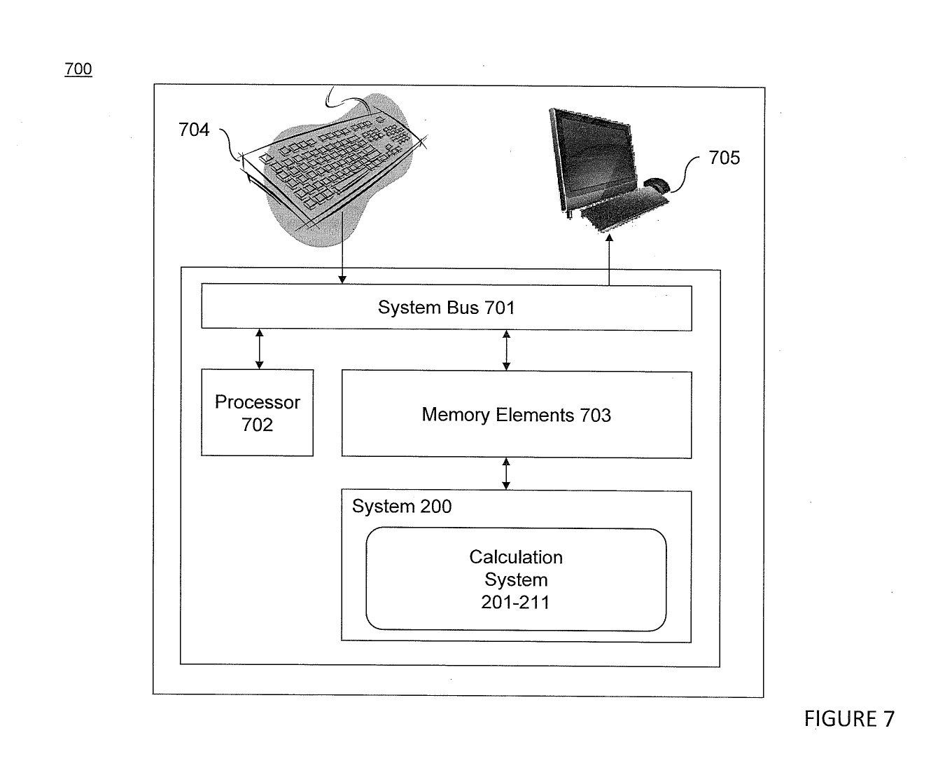

### BACKGROUND OF THE INVENTION

The present invention relates to case management history and analytics. More specifically, a technique for determining the health of a business process based on a set of current indicators and forecasting analysis.

Today, human driven business processes require greater flexibility to deal with semi-structured collaborative activities and multiple runtimes/systems over a long period of time. Many times, a fully specified end-to-end process model can not be implemented or maintained due to the ever changing nature of the business process.

As a result, a flexible business process management system which does not force users to stay within the limits of a rigid model is needed.

### SUMMARY OF THE INVENTION

One aspect of the present invention provides a method of calculating a key performance indicator to determine a health of a case, including: obtaining at least one correlated trace from (i) task descriptions or (ii) data related to the task descriptions or a process instance; calculating at least one current metric using (i) the task descriptions, (ii) the data, (iii) the correlated trace or (iv) a first model; calculating at least one prognostic metric using a second model; and creating at least one combination metric from the current metric and the prognostic metric; where at least one of the steps is carried out using a computer device.

Another aspect of the present invention provides a calculation system for calculating a key performance indicator to determine a health of a case, the system including: an obtaining module adapted to obtain at least one correlated trace from (i) task descriptions or (ii) data related to the task descriptions or a process instance; a first calculating module adapted to calculate at least one current metric using (i) the task descriptions, (ii) the data, (iii) the correlated trace or (iv) a first model; a second calculating module adapted to calculate at least one prognostic metric using a second model; and a first creating module adapted to create at least one combination metric from the current metric and the prognostic metric.

Another aspect of the present invention provides a calculation system for calculating a key performance indicator to determine a health of a case, the system including: an obtaining module adapted to obtain at least one correlated trace from (i) task descriptions or (ii) data related to the task descriptions or a process instance; a first creating module adapted to create a first model using the correlated trace; a second creating module adapted to create a second model using the correlated trace; a first calculating module adapted to calculate at least one current metric using (i) the task descriptions, (ii) the data, (iii) the correlated trace or (iv) the first model; a second calculating module adapted to calculate at least one prognostic metric using the second model; and a third calculating module adapted to calculate at least one combination metric from the current metric and the prognostic metric.

Another aspect of the present invention provides a computer readable storage medium tangibly embodying a computer readable program code having computer readable instructions which when implemented, cause a computer to carry out the steps of a method including: obtaining at least one correlated trace from (i) task descriptions or (ii) data related to the task descriptions or a process instance; calculating at least one current metric using (i) the task descriptions, (ii) the data, (iii) the correlated trace or (iv) a first model; calculating at least one prognostic metric using a second model; and creating at least one combination metric from the current metric and the prognostic metric.

### DETAILED DESCRIPTION OF THE PREFERRED EMBODIMENTS

Business process management (BPM) offers a wide array of tools and technologies to support efficient and effective business operations—from validation and simulation of process models at design-time, over application integration and workflow routing at runtime all the way to compliance and performance monitoring. While the benefits for well structured and highly repetitive processes are undeniable, traditional business process management lacks flexibility and agility in semi-structured, human-centric applications.

Take for example, a corporation which sells products to customers around the globe. BPM can manage the process from the point of receiving an order to delivery of the product to the customer. A single order from a client can be considered a single process instance (PI) for purposes of this example. It should be noted that a PI could be anything as defined by the administrator. PI's are also known as case instances. The PI has many tasks associated with it. For example, creating a new case, assigning the new case to a manager, assigning the new case to a specialist, sending the order to the system, etc. are all examples of tasks which can be associated to a PI. In addition, a PI can have task related data associated with it. In this case, as a PI progresses towards completion, the PI accumulates more data as more tasks execute. Examples of this data include client order history, order amount, client's name and address. An administrator can setup the BPM system to have these tasks and add task descriptors to the tasks. For example, the task of “creating a new case” can have a task descriptor of “creating a new case, creating a new case in the system and add the appropriate case details”.

Case Management represents a paradigm shift putting the goal and context of a business operation into the center of attention rather than the sequence of actions. This shift empowers knowledge workers to choose the appropriate steps to execution, to interact and communicate naturally with their peers and leverage social networks, and to extend the scope and handling of a business case as dictated by a specific situation. Less predefined structures, however, open the door to undetected exceptions and possible derailment, thereby creating undesired outcomes.

While enabling ad-hoc manipulations to predefined business operations, one challenge of advanced case management is to iteratively develop policies and best-practices guiding the behavior of all participants, to maintain oversight of the end to-end case execution, and to analyze both execution traces and case data to improve the overall efficiency and/or to ensure regulatory compliance. In short, advanced case management attempts to transfer many of the tools and technologies from traditional BPM onto more flexible, faster deployable and more human friendly operation environments. As part of this effort, the present invention implements a portion of the ongoing research on Case Health—an assessment of the good standing of a particular case, based on a set of current measurements and forecasting analysis of expected case evolution. Seamlessly integrated into the case modeling and case worker environments, the present invention provides continuous monitoring and predictive analysis of case health indicators which enables early identification of “at risk” cases, notifies specified user(s) in real-time, and initiates or recommends remedial actions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described according to embodiments of the invention. It will be understood that each step and/or module described herein, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

One embodiment of the present invention is a method of calculating a key performance indicator to determine a health of a case. In a first step, base data is collected from a data source. Base data can include structured or unstructured data. Structured data can be records which are typically parsed using some sort of algorithm. For example, comma delimited files and database records can both be forms of structured records since both of these records can be parsed using standard file parsing algorithms. Free form documents can be free form text contained within any containers such as word documents or webpages. The data source can be any source from which data can be obtained. For example, data can be obtained via file transfer protocol (FTP), database or any webfeeds.

In a second step, the base data is converted into structured data, if needed. This can be done using any of the known methods used today such as optical character recognition (OCR) or any other means.

In a third step, a correlated trace is obtained from task descriptions or data related to either task descriptions or process instances. A correlated trace includes (i) the tasks and data which relate to a particular process instance and (ii) the relationship between the task/data and the process instance. A correlated trace can be created using any known method.

For example, one method used today is known as the Business Provenance method. This method is exemplified in a fourth step, which analyzes the task descriptions and/or data related to the task descriptions or process instances (hereinafter “Related Data”). This analysis is used in a fifth step, in order to relate the Related Data to a process instance.

Using the Business Provenance method, basic relations between a task and the manipulated data or a task and the corresponding process instance can be established based on the information the task record holds. Business Provenance can use the concept of record references to materialize this information upon creating the task record. For example when a task is executed, its recording probe adds to the task record a reference to the offered challenge based on the best available application specific identification, for example the record id. The correct data record is then located in the provenance graph, and a relation is created between those two records.

Other relations are established by utilizing data outside of provenance graph, such as data stored in content repositories. Additionally text analytics can be used to process emails, to categorize them, and to extract from the emails data that is then stored as new entries in provenance graph. Process mining and discovery algorithms can also be used to create new relations that identify potential processes. Further, creation of relations and entries can add new entries that may be later processed.

For more details on this method, a complete description of the Business Provenance method can be found in “Business Provenance—A Technology to Increase Traceability of End-to-End Operations”, Curbera et al., Proceedings of the OTM 2008 Confederated International Conferences, November 09-14, 2008, pp. 100-119, as well as patent publications US20100114627A1, US20100114628A1, US20100114629A1, and US20100114630A1 which is incorporated herein by reference.

In a sixth step, a first and/or second model can be created using the correlated traces created in the third step. For example, assume a business process. In the first step of the business process, the manager creates the challenge using a Web-front-end to the central Record Management System. This task triggers an automated email informing the employee about the challenge. To claim the achievement, the employee has to provide evidence which can take various forms: a contract or receipt, a fax from the sales customer, a pointer to a different revenue database, etc. Typically, the evidence is available electronically and it is attached to an e-mail sent to the manager by the employee. Upon reviewing the evidence, the manager evaluates the challenge and in case of achievement marks its status as “achieved” Periodically, the latest achievement data is collected and fed into the Payroll System. Finally, the paycheck is issued to the employee.

In the given example, one might argue that the process is not well designed. But regardless how carefully an application is architected, there will always be gaps between the different systems involved, there will always be data that does not fit into predefined forms, and there will always be exceptions in the execution. Rather than requiring a full scale, heavyweight data integration, our approach focuses on recording meta-data concerning relevant objects and events into a centralized and easily accessible store with links into the original systems; automating correlation of the meta-data to establish execution traces, versioning histories, and other relevant relations; and finally deep analysis to detect situations after the fact, raise alerts while monitoring continuously, and even interfere with execution to prevent compliance violations.

An example of a model which can be generated off of the previously described business process, is illustrated in the following example. In this example, there are five dimensions of business process model. The business artifacts fall into one of the following five dimensions:

(1) Data Records: Data records represent a business artifact that was produced or changed during execution of a business processes. Typically those artifacts include documents, e-mails, and database records. The provenance store represents each version of such an artifact separately. Thus, two data records for the same challenge document can be as follows: one represents the challenge in the state “offered” and another in the later state “achieved”.

(2) Task Records: Task records are the representation of the execution of one particular task. Such tasks might be part of a formally defined business process or being stand-alone, might be fully automated or manual. Both task records are part of the challenge process. As a task manipulates data, a relationship is created between the corresponding task record and the affected data records.

(3) Process Records: A process record represents one instance of a process. In automated business management systems, tasks are executed by processes. Hence, each task record is associated with the corresponding process record.

(4) Resource Records: Resource records represent a person, a runtime or a different kind of resource relevant to the selected scope of business provenance; an actor of a particular task is an example of such a record. In one example, an employee and her manager are represented, both related to the achieved challenge.

(5) Custom Records: Custom records provide an extension point to capture domain specific, mostly virtual artifacts like compliance goals, alerts and checkpoints. Nodes of the provenance graph represent these five classes of records. Edges between nodes are made based on correlation between two records, Relation Records represent the edges. These are the records generally produced as a result of relation analysis among the collected records. For example, custom records can show the path which is most executed by a user.

In step seven of the key indicator performance calculator process for determining health of a case, a current metric is calculated using the task descriptions, data, correlated traces and/or models. In an eight step, a prognostic metric is calculated using a second model. The current metric represents the current state of any particular process instance, otherwise known as the “Case Health”. The current metric can be computed on the basis of conducting statistical analysis on information retrieved from at least a partial trace of a currently running process instance, and a collection of completed traces of the same process. For example, the current case health can show whether the set of tasks executed in a process instance match the most frequent task path taken historically for a business process. For example, current case health can show whether the time taken by the case for a particular task is greater than, equal to or less than the average time taken to execute the same task by previous process instances. Current case health can also show which tasks are most frequently executed next from a given task “t” based on an analysis of historical traces, where “t” is the task currently being executed in a process instance. There are two different kinds of analytics for computing case health. Current case health, or the “current metric”, is determined based on the process instance in question alone and yields results depending on events that have already occurred. Predictive case health, or the “prognostic metric”, can depend on a probabilistic model that has been derived from analytics conducted on aggregating many (previously executed) process instances and is projected onto the process instance in question to predict events that might occur as the execution of the case proceeds.

Indicators that constitute the overall case health depend on the individual case solution. In general, there are three classes of health indicators: performance indicators, derailment indicators, and anomalous behavior indicators. Most indicators can be both detected in the execution so far as well as predicted in the execution continuation. Each individual indicator is either discrete (normal, warning, alert) or has thresholds assigned to be mapped into discrete values.

A performance indicator refers to the timing of events, like a deadline, the duration, the idle-time or the count of repeating or reopening the particular task. When there is a deadline assigned to a task or a milestone, it seems simple to check if it has passed already. Since the deadline might depend on other events (e.g. respond with customer report to the request in 5 business days), current case health analytics use rules to determine the status of each deadline. Besides raising alerts in case of timer expiration, there are also warnings for deadlines being relatively near. With the knowledge derived from other instances, predictive analytics calculates the likelihood of missing a deadline. By aggregating process instance traces, a probabilistic graph can be built, where each node is a case outcome or state, and each edge represents the transition between two such states. If the graph is acyclic, simple application of the chain rule of conditional probabilities can allow prediction of the likelihood of any given outcome. Suppose our system has access to the data content values accessible to a case worker at a given decision point (i.e. a point where the execution branches) in such a graph. By applying a decision tree learning algorithm, the correlation can be computed between the content of documents accessible to the case worker at that point and the execution of one of the descendent activities or next steps that the case worker can potentially take when handling the case. In other words, the outcome of an activity instance based on the contents of the documents accessible to a case worker when he or she executes that activity can be predicted.

A derailment indicator refers to a situation that is legitimate with respect to the case solution but has been marked as undesirable, like the ending up in a negative situation (e.g. rejecting an order and thus loosing business), skipping a critical task or missing a crucial document (which might have consequences in court), or any foreseen exception. While current analytics can detect such situations to trigger remedial actions, predictive analytics has an even greater value by calculating the probabilities of derailment with respect to available choices, and thus giving guidance in making the right decisions.

In contrast, an anomaly indicator refers to a situation that lies outside of the legitimate behavior, such as a violation of a policy or the likelihood of a particular execution sequence being fraudulent. Current case health analytics based on rules cover the majority of such situations while predictive early warnings might be useful in select cases. In addition, an area of current research is to extract a notion of “normal” behavior from the past case execution traces that can be fed into the analytics algorithms. Depending on the severity level of each indicator, remedial action can be triggered from passive reporting on demand, over alerts sent via email or IM, to meetings being scheduled automatically, and finally as a last resort the halting of the current case.

In addition, it should be noted that a custom indicator can also be calculated. The custom indicator can take input from a user, though not required, and output anything defined by the user. For example, the custom indicator can calculate the average time for tasks to complete in the current process instance or determine whether the time taken by each task in the current process instance is greater than or equal to or less than the historical average time taken in the past. In addition, the custom indicator can show the tasks which are most frequently executed after the current task. For more information, please refer to “Integrated Case Management History and Analytics”, Martens et al., Proceedings of the 2011 IEEE 27th International Conference on Data Engineering Workshops, April 2011, pp. 238-242 which is incorporated herein by reference.

In a ninth step a combination metric is created using (i) the current metric calculated in the seventh step and (ii) the prognostic metric calculated in the eighth step. Any number of calculations or statistics can be used in order to create the combination metric. For example, an average between the current and prognostic metric, a weighted average, or a function can be calculated. The function can take, as an input, the current and/or prognostic metrics, and output anything defined by the user. Another embodiment of the present invention exemplifies one such combination metric. Here, assume that several current and prognostic metrics are calculated for a process instance.

A time on a task metric can be computed by maintaining a list of completion times for a given task extracted from a set of historical completed process instances, computing the average completion time of each task using standard statistical averages, and checking whether the current time for completion of a task exceeds its computed average.

A case path metric can be computed by mining a graph showing the frequency of execution of each case path from a set of historical case instances. Then the current path of a running case instance on this graph is plotted and the deviation from the most frequent paths in this graph is calculated. Deviation between two paths can be computed by first converting each path to a string format, determining each string's ascii (or decimal) value and then computing the distance between two decimal values on the basis of existing distance metrics such as the Jaro Winkler distance metric. If the deviation is high, a case path alert would be generated.

A case pattern metric can be a case pattern such as a loop. The objective of this metric is to check how frequently tasks execute in this loop in a running case instance. If the execution of tasks in this loop is greater than a threshold, an alert is generated.

A watched task critical metric can be calculated when the user selects one or more tasks to “watch.” This prognostic metric invokes algorithms to compute the probability with which these tasks are likely to execute in the future of a running case instance. Algorithms used could be one of a variety such as (a) decision trees, (b) probabilistic process models. If the probability of execution of one or more tasks in the watched list is greater than a threshold, an alert is generated.

The combination metric represents an average of the aforementioned tasks. It should be noted that the combination metric created in the ninth step can be displayed and/or sent to any destination such as a user, data source or other system.

In a tenth step of the method, a task, in response to the results of the combination metric, can be (i) automatically initiated or (ii) offered as an option to an entity according to an embodiment of the present invention. An entity is anything or anyone who can receive the results of the combination metric such as a user or computer system. A task can be anything executed on a computer device. The task can be part of the original process instance or the task can be an independent task which is not part of the original process instance. Some examples of tasks are scheduling a meeting with a manager to discuss the combination metric on an electronic calendar, scheduling a site visit to the client on a client's electronic calendar or providing additional evidence for the case.

Further, these tasks can be part of a list maintained by the system according to an embodiment of the present invention. This list can be configured by a user or administrator of the system before or after a case is initiated by the system.

The administrator or user can configure the tasks on the list to be automatically run or offered as an option based on the value of the combination metric and/or a probability of the task according to an embodiment of the present invention. For example, the administrator or user can set a threshold for either the value of the combination metric or a probability of the task. If the combination metric is meets a threshold value and/or if a probability of the task meets a threshold value, then the task can either be automatically initiated or offered to an entity as an option to initiate. The probability of the task can be the probability that the task will be run in the future based on a probabilistic model. If an option is offered to an entity, then the entity can choose to initiate the offered task or not initiate the offered task.

In an eleventh step, new data can be received. This new data can be used in a twelfth step to dynamically update the model(s) created in the sixth step. The updated models can then be used to recalculate current, prognostic and/or combination metrics.

Another embodiment of the present invention is a system (hereinafter “system”) for calculating a key performance indicator to determine a health of a case in accordance with an embodiment of the present invention. The system can include at least one processor coupled to memory elements through a system bus. As such, the system can store program code within the memory elements. The processor can execute the program code accessed from the memory elements via the system bus. In one aspect, for example, the system can be implemented as computer that is suitable for storing and/or executing program code. It should be appreciated, however, that the system can be implemented in the form of any system including a processor and memory that is capable of performing the functions described within this specification.

The memory elements can include one or more physical memory devices such as, for example, local memory and one or more bulk storage devices. Local memory refers to random access memory or other non-persistent memory device(s) generally used during actual execution of the program code. Bulk storage device(s) can be implemented as a hard disk drive (HDD), solid state drive (SSD) or other persistent data storage device. The system also can include one or more cache memories (not shown) that provide temporary storage of at least some program code in order to reduce the number of times program code must be retrieved from bulk storage device during execution.

Input/output (I/O) devices such as a keyboard, a display, and a pointing device optionally can be coupled to the system. The I/O devices can be coupled to the system either directly or through intervening I/O controllers. Network adapters also can be coupled to the system to enable the system to become coupled to other systems, computer systems, remote printers, and/or remote storage devices through intervening private or public networks. Modems, cable modems, and Ethernet cards are examples of different types of network adapters that can be used with the system.

The memory elements can store the system, including the Calculation system. The processor can execute the system to implement the processes and methods described herein.

According to another embodiment of the invention a system is used for calculating a key performance indicator to determine a health of a case. The system includes a collecting module which collects base data from a data source as discussed in the previously described first step. If the base data is not in a structured data format, the converting module converts the base data into structured data as discussed in the previously described second step.

The obtaining module obtains a correlated trace from task descriptions or data related to either task descriptions or process instances as described in the previously described fourth step. The analyzing module analyzes Related Data in order to enable the relating module to create relationships between the Related Data and a process instance as described in the previously described fourth and fifth steps.

The first creating module creates a first model using the correlated traces as described in the previously described sixth step. This model typically represents the current state of the process instance according to a preferred embodiment of the present invention. The second creating module creates a second model using the correlated traces as described in the previously described sixth step. This model typically represents the prognostic state of the process instance according to a preferred embodiment of the present invention. In addition, the second model can be a probabilistic model according to another embodiment of the present invention. The probabilistic model can be computed by known techniques from a set of business process execution traces which are obtained from the provenance system. The probabilistic model provides the probability of reaching a given task from any other task. The first calculating module calculates a current metric as described in the previously described seventh step. The second calculating module calculates a prognostic metric as described in the previously described eighth step. The offering module offers a task to be initiated as described in the previously described tenth step. The initiating module initiates a task as also described in the previously described tenth step.

The receiving module can receive new data at any time, even while the system is currently running other calculations, as described in the previously described tenth_step. This new data is used by the updating module to update the first and/or second models as described in the previously described eleventh step. The updated first and/or second models are used by the first calculating module, second calculating module or third calculating module to recalculate the current, prognostic and/or combination metrics.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The embodiments described herein illustrate the architecture, functionality, and operation of possible implementations of systems, methods and computer program products according to various embodiments of the present invention. In this regard, each embodiment may comprise a module, segment, or portion of code, which comprises one or more executable instructions for implementing the specified logical function(s). It should also be noted that, in some alternative implementations, the functions noted herein may occur out of the order noted. For example, two steps described in succession may, in fact, be executed substantially concurrently, or the steps may sometimes be executed in the reverse order, depending upon the functionality involved. It will also be noted that each step and/or module, can be implemented by special purpose hardware-based systems that perform the specified functions or acts, or combinations of special purpose hardware and computer instructions.

1. A method of calculating a key performance indicator to determine a health of a case, comprising:
obtaining at least one correlated trace from: (i) a plurality of task descriptions; or (ii) data related to said plurality of task descriptions or a process instance;
calculating at least one current metric using; (i) said plurality of task descriptions; (ii) said data; (iii) said at least one correlated trace; or (iv) a first model;
calculating at least one prognostic metric using a second model; and
calculating at least one combination metric from said at least one current metric and said at least one prognostic metric;
wherein the obtaining step, the current metric calculating step, the prognostic metric calculating step, and the combination metric calculating step is are carried out using a computer device.

2. The method according to claim 1 wherein: (i) said first model; or (ii) said second model is created from said at least one correlated trace.

3. The method according to claim 1 wherein said first model comprises: (i) a plurality of nodes correlated with said plurality of task descriptions; and (ii) at least one relationship between at least two of said plurality of nodes.

4. The method according to claim 3 wherein said at least one relationship is determined by analyzing; (i) said data or (ii) said plurality of task descriptions.

5. The method according to claim 1 wherein said obtaining step comprises the step of relating said process instance to (i) at least one of said plurality of task descriptions; or (ii) at least a portion of said data.

6. The method according to claim 1 wherein said at least one combination metric is a weighted average of said at least one current metric and said at least one prognostic metric.

7. The method according to claim 1 wherein: (i) said at least one current metric; or (ii) said at least one prognostic metric is selected from a group consisting of a performance indicator, a compliance indicator, an anomaly indicator and a custom indicator.

8. The method according to claim 1, further comprising:
receiving more data related to said plurality of task descriptions; and updating said first model or said second model using; (i) said more data; (ii) said at least one current metric; (iii) said at least one prognostic metric; or (iv) said at least one combination metric.

9. The method according to claim 1 further comprising the step of offering a task as an option to an entity in response to (i) said at least one combination metric; or (ii) a probability of said task.

10. The method according to claim 1 further comprising the step of initiating a task in response to (i) said at least one combination metric; or (ii) a probability of said task.

11. The method according to claim 1 wherein said first model is a business process model.

12. The method according to claim 1 wherein said second model is a probabilistic process model.

13-20. (canceled)
